(19) United States
(12) Patent Application Publication
(10) Pub. No.: US 2024/0221199 A1
(43) Pub. Date: Jul. 4, 2024

(54) METHOD AND SYSTEM FOR MEASURING PLANAR FEATURES IN 3D SPACE USING A COMBINATION OF A 2D CAMERA AND A DEPTH SENSOR

(71) Applicant: Konica Minolta Business Solutions U.S.A., Inc., San Mateo, CA (US)

(72) Inventor: Jie Kulbida, Broomfield, CO (US)

(73) Assignee: Konica Minolta Business Solutions U.S.A., Inc., San Mateo, CA (US)

(21) Appl. No.: 18/091,453

(22) Filed: Dec. 30, 2022

(51) Int. Cl. G06T 7/55; G06T 7/60; G06T 7/80

(52) U.S. Cl. CPC G06T 7/55; G06T 7/60; G06T 7/80; G06T 2207/10028

(57) ABSTRACT

A system for measuring planar features includes a 2D camera, a depth camera, and a computer system. The 2D camera captures a 2D image of an object, and the depth camera captures a depth image of the object. The object includes a feature in an object plane. The computer system obtains calibration data that establish a correspondence between the 2D camera, the depth camera, and a calibration plane. The computer system further determines a distance between the 2D camera and the object plane using the depth image and the calibration data, and computes a true measurement of the feature based on the feature captured in the 2D image and the distance.

### BACKGROUND

Many different methods for measuring dimensions of objects using cameras exist. However, for applications that demand a high level of precision, such as for quality control in a manufacturing plant, traditional devices, such as calipers or coordinate measuring machines remain the standard. Using these devices involves human intervention, requires contact with the object to be measured, thus rendering it tedious, time-consuming, and costly. Alternative systems and methods for performing such measurements are, therefore, desirable.

### SUMMARY

In general, one or more embodiments of the invention relate to a system for measuring planar features, the system comprising: a 2D camera that captures a 2D image of an object, wherein the object comprises a first feature in a first object plane; a depth camera that captures a depth image of the object; and a computer system that: obtains calibration data that establish a correspondence between the 2D camera, the depth camera, and a calibration plane, determines a first distance between the 2D camera and the first object plane using the depth image and the calibration data, and computes a true measurement of the first feature based on the first feature captured in the 2D image and the first distance.

In general, one or more embodiments of the invention relate to a method for measuring planar features, the method comprising: capturing a 2D image of an object, using a 2D camera, wherein the object comprises a first feature in a first object plane; capturing a depth image of the object using a depth camera; obtaining calibration data that establish a correspondence between the 2D camera, the depth camera, and a calibration plane; determining a first distance between the 2D camera and the first object plane using the depth image and the calibration data; and computing a true measurement of the first feature based on the first feature captured in the 2D image and the first distance.

In general, one or more embodiments of the invention relate to a non-transitory computer readable medium (CRM) storing computer readable program code for measuring planar features, wherein the computer readable program code causes a computer system to: obtain a 2D image of an object from a 2D camera, wherein the object comprises a first feature in a first object plane; obtain a depth image of the object from a depth camera; obtain calibration data that establish a correspondence between the 2D camera, the depth camera, and a calibration plane; determine a first distance between the 2D camera and the first object plane using the depth image and the calibration data; and compute a true measurement of the first feature based on the first feature captured in the 2D image and the first distance.

Other aspects of the invention will be apparent from the following description and the appended claims.

### BRIEF DESCRIPTION OF DRAWINGS

FIG. 1 schematically shows a system for measuring planar features, according to one or more embodiments.

FIG. 2 schematically shows a calibration configuration, according to one or more embodiments.

FIG. 3 shows a flowchart of a method for calibrating a system for measuring planar features, according to one or more embodiments.

FIG. 4 schematically shows a measurement configuration, according to one or more embodiments.

FIG. 5 shows a flowchart of a method for measuring a feature using a system for measuring planar features, according to one or more embodiments.

FIG. 6 shows a computing system, according to one or more embodiments.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third) may be used as an adjective for an element (i.e., any noun in the application). The use of ordinal numbers is not to imply or create a particular ordering of the elements nor to limit any element to being only a single element unless expressly disclosed, such as by the use of the terms “before,” “after,” “single,” and other such terminology. Rather the use of ordinal numbers is to distinguish between the elements. By way of an example, a first element is distinct from a second element, and the first element may encompass more than one element and may succeed (or precede) the second element in an ordering of elements.

In general, embodiments of the invention provide an apparatus, a method, and a non-transitory computer readable medium (CRM) for measuring planar features in 3D space using a combination of a 2D camera and a depth sensor.

Embodiments of the disclosure are capable of measuring the true dimension of a planar feature (e.g., the diameter of a circular feature on a flat surface) of an object (e.g., a cylinder), using a combination of a high-resolution 2D camera and a low-resolution depth camera. A description is subsequently provided in reference to the figures.

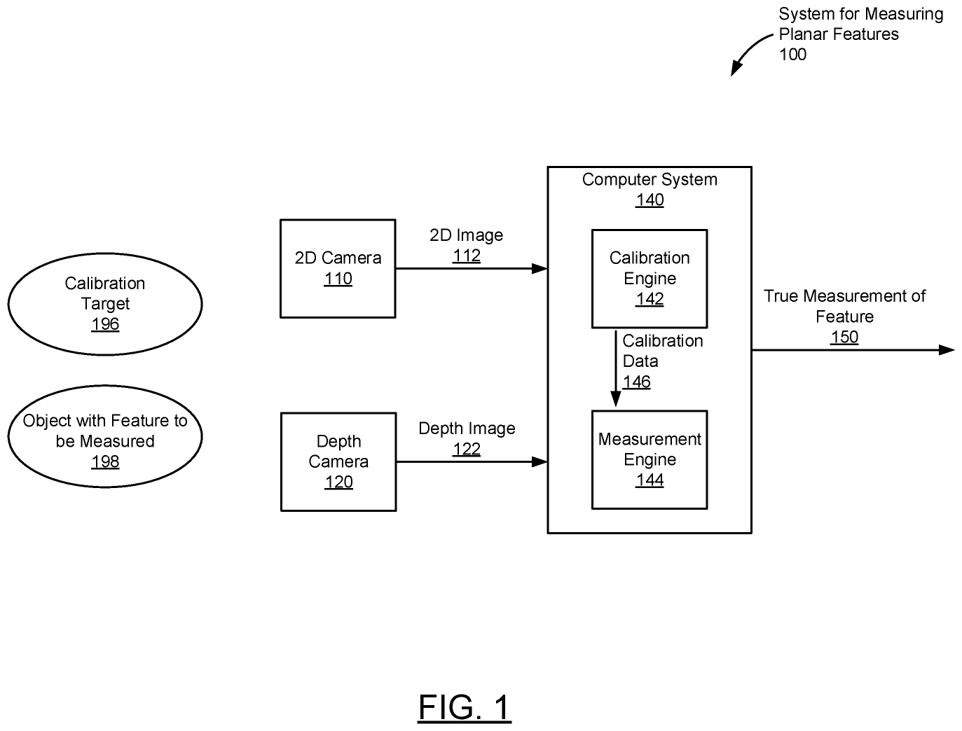

FIG. 1 schematically shows a system (100) for measuring planar features, according to one or more embodiments. The system (100) includes a 2D camera (110), a depth camera (120), and a computer system (140). The computer system (140) receives a 2D image (112) of an object with a feature to be measured (198) from the 2D camera (110). The computer system (140) further receives a depth image (122) of the object (198) from the depth camera (120). Using the 2D image (112) and the depth image (122), a measurement engine (144) of the computer system predicts a true measurement (150) of the feature, based on the feature captured in the 2D image (112). The measurement engine (144) relies on calibration data (146) provided by the calibration engine (142). The calibration data (146), in one or more embodiments, establish a correspondence between the 2D camera and the depth camera, and between the cameras and a calibration plane, as further discussed below. The calibration engine (142) generates the calibration data (146) based on a 2D image of a calibration target (196) and a depth image of the calibration target (196).

The 2D camera (110) may be any type of 2D camera, for example, a monochrome or color CCD or CMOS camera. In one or more embodiments, the 2D camera is selected to be high-resolution. For example, the 2D camera (110) may have a resolution of 20 megapixels, e.g., in a configuration of 5472×3648 pixels, with a pixel size of, for example, 100 μm when set up for imaging an object with dimensions of up to 540 mm×360 mm. The 2D camera (110) may have any optical characteristics. For example, the 2D camera, including any combination of lenses of the 2D camera, may operate at any wavelength in the visible or invisible spectrum of light, may have any focal length, may have any magnification, any sensor size, etc. The 2D camera (110) may face an area where the calibration target (196) or the object (198) may be placed. For example, the 2D camera may be installed above a measuring table, a conveyor belt, etc. The 2D camera (110) may generally face the calibration target (196) or the object (198), but without requiring a particular distance or alignment. Broadly speaking, the selection of the 2D camera (110), including selection and/or configuration of lenses of the 2D camera, and/or selection of a location of the 2D camera (110) may be made based on field of view requirements, e.g., dictated by the size of the object (198) and mounting location constraints, and/or accuracy requirements. It may be desirable to maximize the size of the image of the object (198) or calibration target (196) on the sensor of the 2D camera, in order to maximize use of the sensor, thereby maximizing overall resolution of the system (100). This may be accomplished in different ways. For example, a lens with higher magnification power may be used if the mounting location of the 2D camera (110) is far from the object. Additionally or alternatively, the distance between object and camera may be adjusted by selection of a shorter distance for smaller objects and a longer distance for larger objects. However, it is not necessary to install the 2D camera (110) at a particular known distance from the calibration target/the object. Further, knowledge of the magnification of the 2D camera/lens combination prior to the calibration process is not required.

The 2D image (112) is the output of the 2D camera (110). 2D images may include a 2D view of the calibration target (196) or the object (198). The 2D image (112) may be provided to the computer system (140) in any format, using any type of interface supported by the computer system (140).

The depth camera (120) may be any type of depth camera, for example, a structured/code light camera, a stereo depth camera, a time-of-flight/LIDAR camera, etc. The depth camera (120) may have a resolution lower than the resolution of the 2D camera (110). For example, the depth camera (120) may have a resolution in the range of one millimeter. Similar to the 2D camera (110), the depth camera (120) generally faces the calibration target or the object, but without requiring precise alignment, and without requiring knowledge of the exact location/orientation of the depth camera.

The depth image (122) is the output of the depth camera (120). Depth images may include at least a 2D view (in depth) of the calibration target or the object. Accordingly, each pixel of a depth image may represent a depth measurement from the depth camera (120) to the calibration target or the object. Thus, even different planes (at different distances from the depth camera (120) may be identified using the depth image (122) The depth image (122) may be provided to the computer system (140) in any format, using any type of interface supported by the computer system (140).

The 2D camera (110) and the depth camera (120) may be discrete units or they may be combined in an assembly. One such example is the Microsoft Kinect system. The 2D camera (110) and the depth camera (120) may be mounted on a gantry or other mechanical support. The distance from the calibration target/the object may be adjustable. Shorter distances may be selected for the measurement of smaller features, and longer distances may be selected for the measurements of larger features, in order to maximize usage of the sensor of the 2D camera (110).

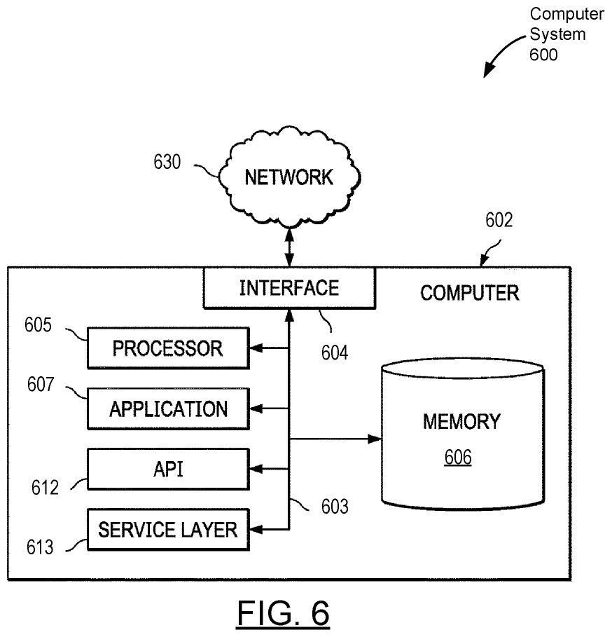

The computer system (140), in one or more embodiments, receives the 2D image (112) and the depth image (122) to generate a true measurement (150) of the feature. The computer system may be any type of computer system, e.g., as described in reference to FIG. 6.

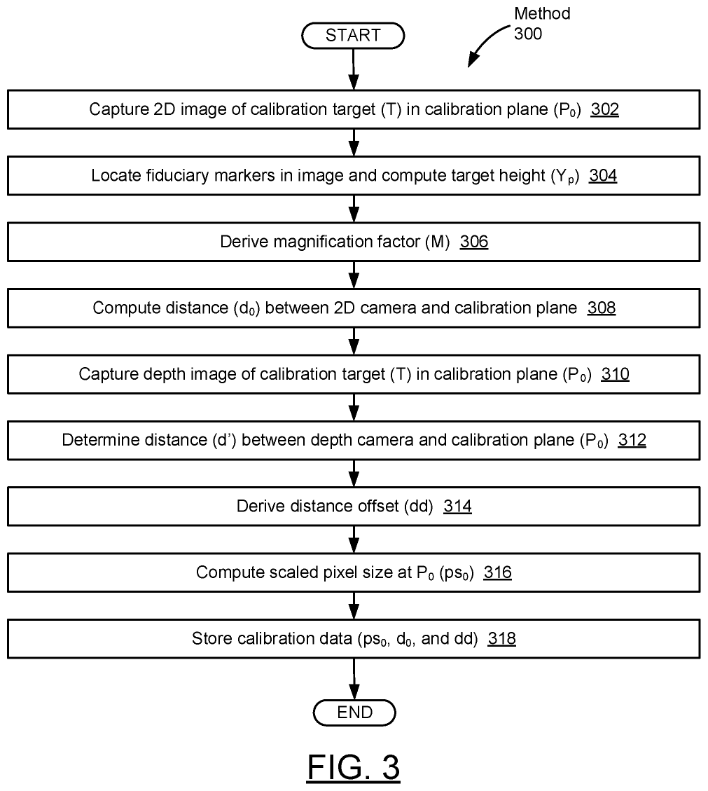

The calibration engine (142), in one or more embodiments, is executed on the computer system (140) to generate calibration data (146) as discussed below. A method such as the method shown in FIG. 3 may be used to generate the calibration data (146).

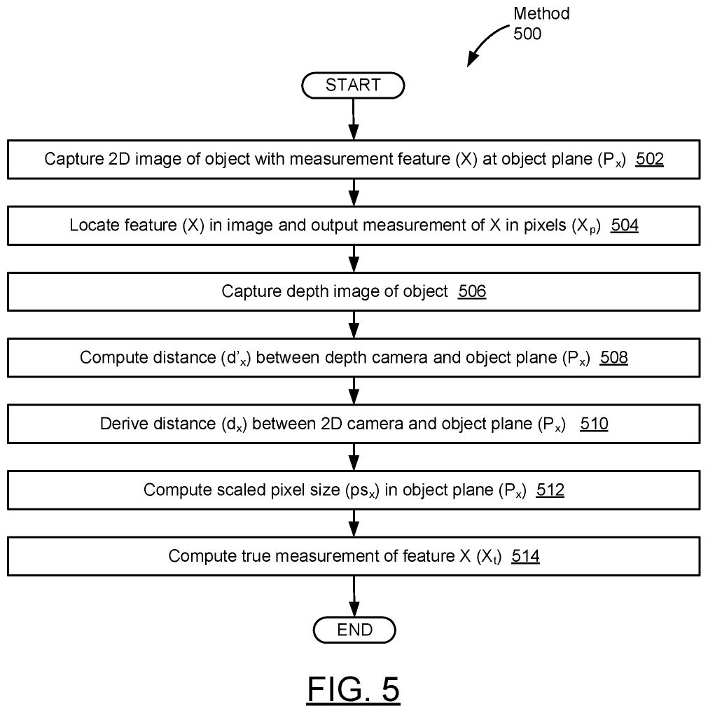

The measurement engine (144), in one or more embodiments, is executed on the computer system (140) to generate the true measurement (150) of the feature. A method such as the method shown in FIG. 5 may be used to generate the true measurement (150). The true measurement may be considered an estimate of the actual feature of the object to be measured (198). The true measurement (150) may be any dimension (e.g., in mm) of any type of feature, such as the diameter of a circular structure, the length or width of a rectangle, etc.

While FIG. 1 shows various configurations of hardware components and/or software components, other configurations may be used without departing from the scope of the disclosure. For example, different combinations of cameras that may be based on different operating principles, and/or may have different resolutions may be used, and/or various components in FIG. 1 may be combined to create a single component. As another example, the functionality performed by a single component may be performed by two or more components.

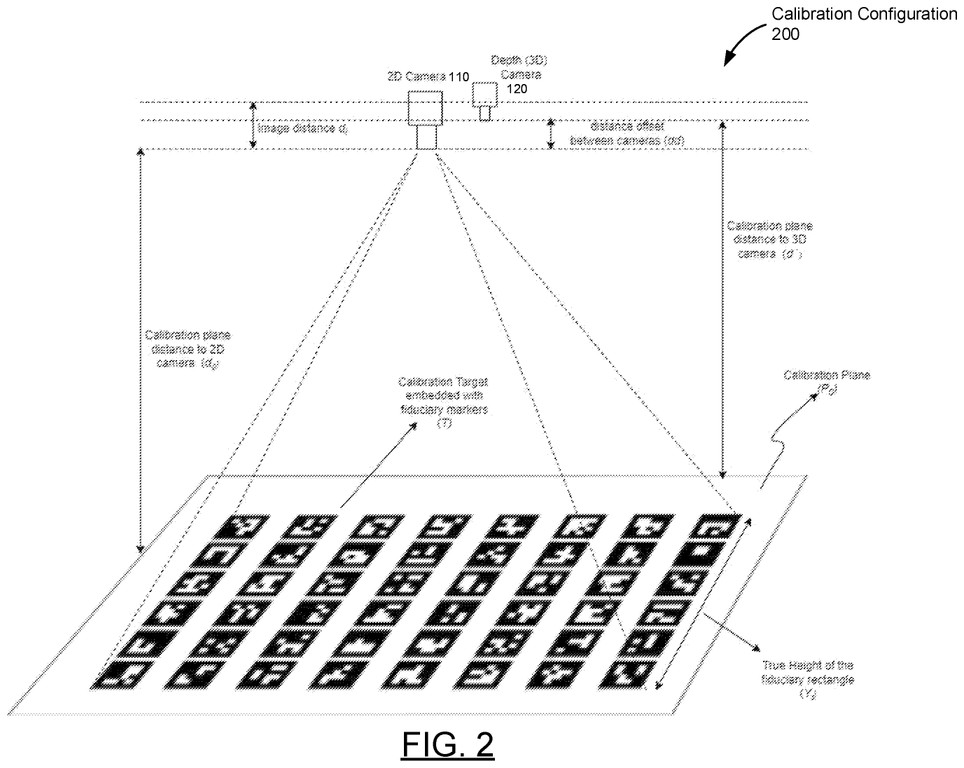

FIG. 2 schematically shows a calibration configuration (200), according to one or more embodiments. The calibration configuration may be used for the execution of the method shown in FIG. 3. In the calibration configuration (200), the 2D camera (110) and the depth camera (120) capture a 2D image (112) and a depth image (122), respectively, of the calibration target (T). The calibration target (T) may have visual features detectable by the 2D camera (110). For example, the calibration target may include a checkerboard pattern, a matrix of dots, etc. In one or more embodiments, the visual features have a known geometry and size to enable calibration. The visual features may be of any type, shape, and/or size. In one embodiment, the calibration target (T) includes fiduciary markers in the form of ArUco markers. The known geometry of the calibration target (T) may include a true height (Yₜ) or true width of the fiduciary rectangle formed by the fiduciary markers, and/or other known dimensions, including relative positions of the fiduciary markers within the calibration target (T). The calibration target (T) is in a calibration plane (P₀). The calibration configuration (200) may be designed such that the height of the target (T) occupies the sensor of the 2D camera (110) mostly or entirely, for maximum resolution. The calibration plane (P₀) is assumed to be approximately perpendicular to the depth axis of the depth camera (120) to ensure that a similar depth would be measured for different locations in the calibration (P₀). A distance (d′) between the depth camera and the calibration plane separates the calibration plane (P₀) from the depth camera (120). A distance (d₀) between the 2D and the calibration plane separates the calibration plane (P₀) from the 2D camera (110). An offset between the 2D camera (110) and the depth camera (120) may be accommodated by the distance offset (dd). The image distance (dᵢ) characterizes the offset from the front of the 2D camera to the image plane where the image is actually formed. The application of these characteristics of the calibration configuration (200) is subsequently discussed in reference to FIG. 3.

FIG. 3 shows a flowchart of a method for calibrating a system for measuring planar features, according to one or more embodiments. The method may be implemented using instructions stored on a non-transitory medium that may be executed by a computer system as shown in FIG. 6.

While the various steps in FIG. 3 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

The subsequently described method may be used to establish calibration data to be used for subsequent execution of the method of FIG. 5. The calibration uses a calibration target (T) with a known geometry to determine a scaled pixel size of the pixels of the camera projected into the calibration plane (P₀). Later, this pixel size in the calibration plane (P₀) may be used to determine a pixel size in an arbitrary plane, thereby enabling determination of a true measurement (based on the numbers of pixels and their size) in that arbitrary plane, for which a distance is measured by the depth camera placed adjacent to the 2D camera.

Turning to the flowchart of FIG. 3, in Step 302, a 2D image of the calibration target (T) in the calibration plane (P₀) is captured.

In Step 304, the fiduciary markers embedded in the calibration target (T) are located by processing the 2D image. Any methods suitable for object detection may be used. These methods may also include steps to correct for lens distortions, perspective distortions, etc. A height (Yₚ) (in pixels of the 2D camera, i.e., using the actual pixel size) of the rectangle formed by the fiduciary markers is computed.

In Step 306, a magnification factor of the 2D camera is determined. The magnification factor (M) at the calibration plane (P₀) is derived using the known height of the 2D camera's sensor array (Yᵢ), and the true (known) height of the fiduciary rectangle (Yₜ):

$$M = \frac{{Y}_{i}}{{Y}_{t}} . \qquad ( 1 )$$

In other words, the magnification factor (M) is the ratio of the true height imaged onto the sensor (i.e., scaled onto the sensor array) and the true height of the fiduciary rectangle itself.

In Step 308, the distance (d₀) between the 2D camera and the calibration plane (P₀) is computed using the lens equation, where the focal length (f) of the 2D camera is known:

$$\frac{1}{f} = \frac{1}{{d}_{0}} + \frac{1}{{d}_{i}} . \qquad ( 2 )$$

Since the magnification produced by a lens is equal to the ratio of image distance and the object distance:

$$M = \frac{{d}_{i}}{{d}_{o}} , \qquad ( 3 )$$

(3) may be rewritten as

$${d}_{i} = M \times {d}_{o} . \qquad ( 4 )$$

By solving (2) for d₀ using (4), the distance (d₀) between the 2D camera and the calibration plane may be obtained:

$${d}_{0} = f \times \frac{( M + 1 )}{M} . \qquad ( 5 )$$

In Step 310, a depth image of the calibration target (T) in the calibration plane (P₀) is captured.

In Step 312, the distance (d′) between the depth camera and the calibration plane is determined. Multiple depth measurements obtained for the calibration plane may be averaged and outliers may be removed to obtain a more robust distance (d′). Any methods for processing 3D image data may be used to determine the distance (d′) from the depth image.

In Step 314, the depth offset (dd) between the 2D camera and the depth camera is derived using

$$d d = {d}_{o} - {d}^{′} . \qquad ( 6 )$$

In Step 316, a scaled pixel size (ps₀) in the calibration plane (P₀) is derived, using the height measured in pixels (Yₚ) and the true (known) height of the rectangle (Yₜ):

$$p {s}_{0} = \frac{{Y}_{t}}{{Y}_{p}} . \qquad ( 7 )$$

In Step 318, the calibration data, including ps₀, d₀, and dd, are stored in volatile and/or non-volatile memory for the execution of the method of FIG. 5.

After execution of the method of FIG. 3, an accurate calibration between the two cameras and the 3D space in which a feature to be measured may be found is established, thereby enabling a mapping between pixel counts of the 2D camera and true dimensions, e.g., in millimeters.

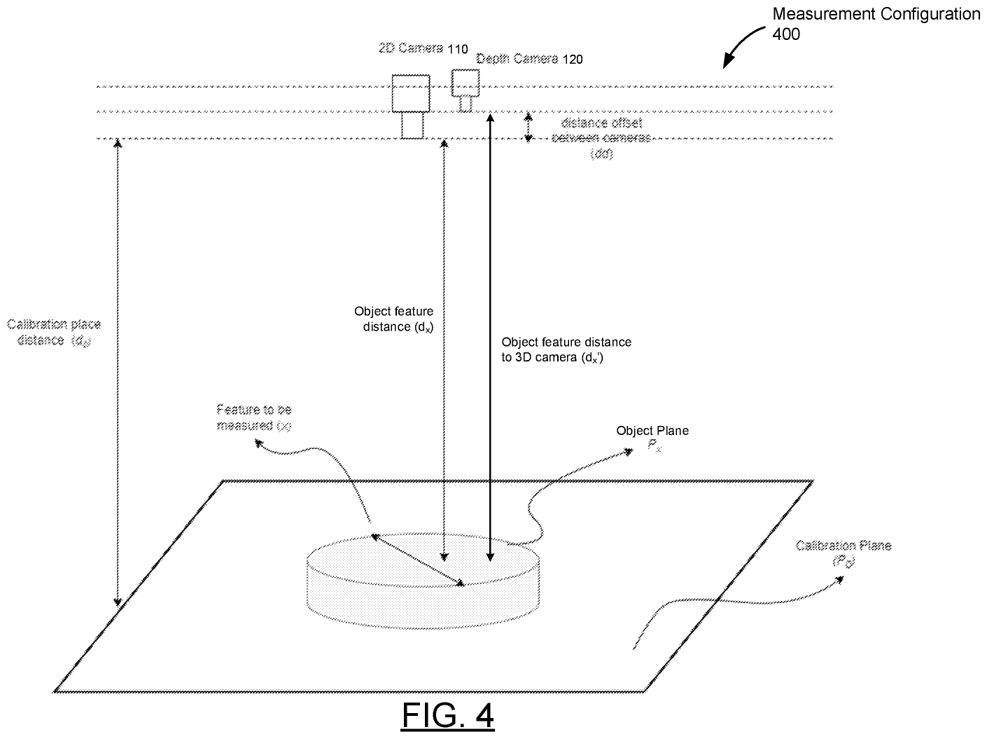

FIG. 4 schematically shows a measurement configuration (400), according to one or more embodiments. The measurement configuration is used for the execution of the method shown in FIG. 5. The measurement configuration (400) is substantially similar to the calibration configuration (200). However, in the measurement configuration (400), the 2D camera (110) and the depth camera (120) capture a 2D image (112) and a depth image (122), respectively, of the feature to be measured (X) in an object plane (Pₓ). The object plane (Pₓ) may be different from the calibration plane (P₀). An object feature distance (dₓ) separates the object plane (Pₓ) from the 2D camera (110). FIG. 4 also shows the offset between the 2D camera (110) and the depth camera (120) (dd), previously determined using the method of FIG. 3. A method for performing a measurement using the measurement configuration (400) is subsequently discussed in reference to FIG. 5.

FIG. 5 shows a flowchart of a method for measuring a feature, according to one or more embodiments. The method may be implemented using instructions stored on a non-transitory medium that may be executed by a computer system as shown in FIG. 6.

While the various steps in FIG. 5 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

Turning to the flowchart of FIG. 5, in Step 502, a 2D image of the object with the feature (X) to be measured in the object plane (Pₓ) is captured.

In Step 504, the feature (X) is located by processing the 2D image. Any methods suitable for feature detection may be used. These methods may also include steps to correct for lens distortions, perspective distortions, etc. The result of the execution of Step 504 may be a measurement of the feature (X) in pixels (Xₚ). For example, assuming that the feature is the diameter of a circular structure, the number of the subset of pixels (i.e., the cardinality) that represents the diameter of the circular structure is obtained, e.g., by counting these pixels.

In Step 506, a depth image of the object with the feature (X) in the object plane (Pₓ) is captured.

In Step 508, the distance (d) between the depth camera and the object plane (Pₓ) is obtained from the depth image. Multiple depth measurements obtained for the object plane may be averaged and outliers may be removed to obtain a more robust distance (d′ₓ). Any methods for processing 3D image data may be used to obtain the distance (d′ₓ) from the depth image.

In Step 510, the distance (dₓ) between the 2D camera and the object plane (Pₓ) is obtained by applying the depth offset (dd) derived at calibration:

$${d}_{x} = {d}_{x}^{′} + dd . \qquad ( 8 )$$

In other words, the distance (d′ₓ) between the depth camera and the object plane is adjusted for the depth offset (dd).

In Step 512, the pixel size of the pixels of the 2D camera (actual pixel size) is scaled into the object plane (Pₓ) to obtain a scaled pixel size in the object plane (psₓ). psₓ is calculated using dₓ, the scaled pixel size in the calibration plane (ps₀), and the distance of the calibration plane to the camera (d₀):

$$p {s}_{x} = p {s}_{0} \times \frac{{d}_{x}}{{d}_{o}} . \qquad ( 9 )$$

In Step 514, the true measurement of the feature X (Xₜ) is computed by multiplying the measurements in pixels (Xₚ) (e.g., a cardinality of a subset of pixels of the 2D camera that represent the true measurement scaled into the 2D image) with the scaled pixel size in the object plane (psₓ):

$${X}_{t} = {X}_{p} \times p {s}_{x} . \qquad ( 10 )$$

The true measurement may subsequently be reported to the user. The method of FIG. 5 may be performed in any object plane. The method of FIG. 5 may be repeated for different objects that may be in the same or in different object planes. The same object may have multiple object planes.

FIG. 6 shows a computing system, according to one or more embodiments. Embodiments may be implemented on a computer system. FIG. 6 is a block diagram of a computer system (602) used to provide computational functionalities associated with described algorithms, methods, functions, processes, flows, and procedures as described in the instant disclosure, according to an implementation. The illustrated computer (602) is intended to encompass any computing device such as a high-performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (602) may include a computer that includes an input device, such as a keypad, keyboard, touch screen, or other device that can accept user information, and an output device that conveys information associated with the operation of the computer (602), including digital data, visual, or audio information (or a combination of information), or a GUI.

The computer (602) can serve in a role as a client, network component, a server, a database or other persistency, or any other component (or a combination of roles) of a computer system for performing the subject matter described in the instant disclosure. The illustrated computer (602) is communicably coupled with a network (630). In some implementations, one or more components of the computer (602) may be configured to operate within environments, including cloud-computing-based, local, global, or other environment (or a combination of environments).

At a high level, the computer (602) is an electronic computing device operable to receive, transmit, process, store, or manage data and information associated with the described subject matter. According to some implementations, the computer (602) may also include or be communicably coupled with an application server, e-mail server, web server, caching server, streaming data server, business intelligence (BI) server, or other server (or a combination of servers).

The computer (602) can receive requests over network (630) from a client application (for example, executing on another computer (602)) and responding to the received requests by processing the said requests in an appropriate software application. In addition, requests may also be sent to the computer (602) from internal users (for example, from a command console or by other appropriate access method), external or third-parties, other automated applications, as well as any other appropriate entities, individuals, systems, or computers.

Each of the components of the computer (602) can communicate using a system bus (603). In some implementations, any or all of the components of the computer (602), both hardware or software (or a combination of hardware and software), may interface with each other or the interface (604) (or a combination of both) over the system bus (603) using an application programming interface (API) (612) or a service layer (613) (or a combination of the API (612) and service layer (613). The API (612) may include specifications for routines, data structures, and object classes. The API (612) may be either computer-language independent or dependent and refer to a complete interface, a single function, or even a set of APIs. The service layer (613) provides software services to the computer (602) or other components (whether or not illustrated) that are communicably coupled to the computer (602). The functionality of the computer (602) may be accessible for all service consumers using this service layer. Software services, such as those provided by the service layer (613), provide reusable, defined business functionalities through a defined interface. For example, the interface may be software written in JAVA, C++, or other suitable language providing data in extensible markup language (XML) format or other suitable format. While illustrated as an integrated component of the computer (602), alternative implementations may illustrate the API (612) or the service layer (613) as stand-alone components in relation to other components of the computer (602) or other components (whether or not illustrated) that are communicably coupled to the computer (602). Moreover, any or all parts of the API (612) or the service layer (613) may be implemented as child or sub-modules of another software module, enterprise application, or hardware module without departing from the scope of this disclosure.

The computer (602) includes an interface (604). Although illustrated as a single interface (604) in FIG. 6, two or more interfaces (604) may be used according to particular needs, desires, or particular implementations of the computer (602). The interface (604) is used by the computer (602) for communicating with other systems in a distributed environment that are connected to the network (630). Generally, the interface (604 includes logic encoded in software or hardware (or a combination of software and hardware) and operable to communicate with the network (630). More specifically, the interface (604) may include software supporting one or more communication protocols associated with communications such that the network (630) or interface's hardware is operable to communicate physical signals within and outside of the illustrated computer (602).

The computer (602) includes at least one computer processor (605). Although illustrated as a single computer processor (605) in FIG. 6, two or more processors may be used according to particular needs, desires, or particular implementations of the computer (602). Generally, the computer processor (605) executes instructions and manipulates data to perform the operations of the computer (602) and any algorithms, methods, functions, processes, flows, and procedures as described in the instant disclosure.

The computer (602) also includes a memory (606) that holds data for the computer (602) or other components (or a combination of both) that can be connected to the network (630). For example, memory (606) can be a database storing data consistent with this disclosure. Although illustrated as a single memory (606) in FIG. 6, two or more memories may be used according to particular needs, desires, or particular implementations of the computer (602) and the described functionality. While memory (606) is illustrated as an integral component of the computer (602), in alternative implementations, memory (606) can be external to the computer (602).

The application (607) is an algorithmic software engine providing functionality according to particular needs, desires, or particular implementations of the computer (602), particularly with respect to functionality described in this disclosure. For example, application (607) can serve as one or more components, modules, applications, etc. Further, although illustrated as a single application (607), the application (607) may be implemented as multiple applications (607) on the computer (602). In addition, although illustrated as integral to the computer (602), in alternative implementations, the application (607) can be external to the computer (602).

There may be any number of computers (602) associated with, or external to, a computer system containing computer (602), each computer (602) communicating over network (630). Further, the term “client,” “user,” and other appropriate terminology may be used interchangeably as appropriate without departing from the scope of this disclosure. Moreover, this disclosure contemplates that many users may use one computer (602), or that one user may use multiple computers (602).

In some embodiments, the computer (602) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, a cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

One or more of the embodiments of the disclosure may have one or more of the following advantages. Embodiments of the disclosure enable a contactless measurement using stationary cameras. Accordingly, no moving components are needed. Only a single calibration at the initialization time may be needed, although an updated calibration may be needed when the camera(s) are moved.

Even though the object with the feature may be 3-dimensional, embodiments of the disclosure perform the bulk of computer vision algorithms in 2D, thereby greatly reducing the computational complexity, and speeding up the processing. With the required imaging and subsequent calculations requiring very little time, a measurement may be performed instantly with no delay. Further, embodiments of the disclosure are cost effective, and the precision of the resulting measurement may be limited only by the resolution of the cameras. Different-size features may be measured simply by adjusting camera distance and/or by selecting a different lens for the 2D camera.

Although the disclosure has been described with respect to a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A system for measuring planar features, the system comprising:
a 2D camera that captures a 2D image of an object,
wherein the object comprises a first feature in a first object plane;
a depth camera that captures a depth image of the object; and
a computer system that:
obtains calibration data that establish a correspondence between the 2D camera, the depth camera, and a calibration plane,
determines a first distance between the 2D camera and the first object plane using the depth image and the calibration data, and
computes a true measurement of the first feature based on the first feature captured in the 2D image and the first distance.

2. The system of claim 1,
wherein the object further comprises a second feature in a second object plane, and
wherein the computer system further:
determines a second distance between the 2D camera and the second object plane, and
computes a true measurement of the second feature based on the second feature captured in the 2D image and the second distance.

3. The system of claim 1, wherein determining the first distance comprises:
determining a distance between the depth camera and the first object plane from the depth image, and
computing the first distance by adjusting the distance between the depth camera and the first object plane for a depth offset between the 2D camera and the depth camera,
wherein the depth offset is obtained from the calibration data.

4. The system of claim 1, wherein computing the true measurement comprises:
computing, for pixels of the 2D camera with an actual pixel size, a scaled pixel size in the first object plane by:
multiplying a scaled pixel size of the pixels in the calibration plane using a ratio of the first distance and a distance between the 2D camera and the calibration plane,
wherein the scaled pixel size in the calibration plane and the distance between the 2D camera and the calibration plane are obtained from the calibration data, and
obtaining the true measurement of the first feature by:
in the 2D image, determining a cardinality of a subset of the pixels of the 2D camera that represent the true measurement scaled into the 2D image, and
multiplying the cardinality by the scaled pixel size of the pixels projected into the first object plane.

5. The system of claim 1, wherein:
the 2D camera, captures a 2D image of a calibration target in the calibration plane,
the depth camera captures a depth image of the calibration target in the calibration plane, and
the computer system, prior to obtaining the calibration data, performs a calibration to determine the calibration data based on a known geometry of the calibration target and a known focal length of the 2D camera.

6. The system of claim 5, wherein determining the calibration data comprises:
determining a magnification factor of the 2D camera, based on the captured 2D image and the known geometry of the calibration target, and
determining a distance between the 2D camera and the calibration plane using the magnification factor and a focal length of the 2D camera.

7. The system of claim 6, wherein determining the calibration data further comprises:
determining a distance between the depth camera and the calibration plane, using the depth image, and
determining a depth offset between the 2D camera and the depth camera using the distance between the 2D camera and the calibration plane and the distance between the depth camera and the calibration plane.

8. The system of claim 5, wherein determining the calibration data comprises:
determining a scaled pixel size of pixels of the 2D camera projected into the calibration plane, using the known geometry of the calibration target.

9. A method for measuring planar features, the method comprising:
capturing a 2D image of an object, using a 2D camera,
wherein the object comprises a first feature in a first object plane;
capturing a depth image of the object using a depth camera;
obtaining calibration data that establish a correspondence between the 2D camera, the depth camera, and a calibration plane;
determining a first distance between the 2D camera and the first object plane using the depth image and the calibration data; and
computing a true measurement of the first feature based on the first feature captured in the 2D image and the first distance.

10. The method of claim 9, further comprising:
determining a second distance between the 2D camera and a second object plane of the object, the second object plane comprising a second feature; and
computing a true measurement of the second feature based on the second feature captured in the 2D image and the second distance.

11. The method of claim 9, wherein determining the first distance comprises:
determining a distance between the depth camera and the first object plane from the depth image; and
computing the first distance by adjusting the distance between the depth camera and the first object plane for a depth offset between the 2D camera and the depth camera,
wherein the depth offset is obtained from the calibration data.

12. The method of claim 9, wherein computing the true measurement comprises:
computing, for pixels of the 2D camera with an actual pixel size, a scaled pixel size in the first object plane by:
multiplying a scaled pixel size of the pixels in the calibration plane using a ratio of the first distance and a distance between the 2D camera and the calibration plane,
wherein the scaled pixel size in the calibration plane and the distance between the 2D camera and the calibration plane are obtained from the calibration data; and
obtaining the true measurement of the first feature by:
in the 2D image, determining a cardinality of a subset of the pixels of the 2D camera that represent the true measurement scaled into the 2D image, and
multiplying the cardinality by the scaled pixel size of the pixels projected into the first object plane.

13. The method of claim 9, further comprising:
capturing a 2D image of a calibration target in the calibration plane, using the 2D camera;
capturing a depth image of the calibration target in the calibration plane, using the depth camera; and
prior to obtaining the calibration data, performing a calibration to determine the calibration data based on a known geometry of the calibration target and a known focal length of the 2D camera.

14. The method of claim 13, wherein determining the calibration data comprises:
determining a magnification factor of the 2D camera, based on the captured 2D image and the known geometry of the calibration target; and
determining a distance between the 2D camera and the calibration plane using the magnification factor and a focal length of the 2D camera.

15. The method of claim 14, wherein determining the calibration data further comprises:
determining a distance between the depth camera and the calibration plane, using the depth image; and
determining a depth offset between the 2D camera and the depth camera using the distance between the 2D camera and the calibration plane and the distance between the depth camera and the calibration plane.

16. The method of claim 13, wherein determining the calibration data comprises:
determining a scaled pixel size of pixels of the 2D camera projected into the calibration plane, using the known geometry of the calibration target.

17. A non-transitory computer readable medium (CRM) storing computer readable program code for measuring planar features, wherein the computer readable program code causes a computer system to:
obtain a 2D image of an object from a 2D camera,
wherein the object comprises a first feature in a first object plane;
obtain a depth image of the object from a depth camera;
obtain calibration data that establish a correspondence between the 2D camera, the depth camera, and a calibration plane;
determine a first distance between the 2D camera and the first object plane using the depth image and the calibration data; and
compute a true measurement of the first feature based on the first feature captured in the 2D image and the first distance.

18. The non-transitory computer readable medium of claim 17, wherein computing the true measurement comprises:
computing, for pixels of the 2D camera with an actual pixel size, a scaled pixel size in the first object plane by:
multiplying a scaled pixel size of the pixels in the calibration plane using a ratio of the first distance and a distance between the 2D camera and the calibration plane,
wherein the scaled pixel size in the calibration plane and the distance between the 2D camera and the calibration plane are obtained from the calibration data; and
obtaining the true measurement of the first feature by:
in the 2D image, determining a cardinality of a subset of the pixels of the 2D camera that represent the true measurement scaled into the 2D image; and
multiplying the cardinality by the scaled pixel size of the pixels projected into the first object plane.

19. The non-transitory computer readable medium of claim 18, wherein:
the 2D camera, captures a 2D image of a calibration target in the calibration plane,
the depth camera captures a depth image of the calibration target in the calibration plane, and
the computer readable program code further causes the computer system to, prior to obtaining the calibration data, perform a calibration to determine the calibration data based on a known geometry of the calibration target and a known focal length of the 2D camera.

20. The non-transitory computer readable medium of claim 19, wherein determining the calibration data comprises:
determining a scaled pixel size of pixels of the 2D camera projected into the calibration plane, using the known geometry of the calibration target.
